(19) United States
(12) Patent Application Publication
(10) Pub. No.: US 2024/0313605 A1
(43) Pub. Date: Sep. 19, 2024

(54) BRUSHLESS MOTOR

(71) Applicant: DENSO CORPORATION, Kariya-city (JP)

(72) Inventor: Noriyuki SUZUKI, Kariya-city (JP)

(73) Assignee: DENSO CORPORATION, Kariya-city (JP)

(21) Appl. No.: 18/674,197

(22) Filed: May 24, 2024

Related U.S. Application Data
(63) Continuation of application No. PCT/JP2022/038482, filed on Oct. 14, 2022.

(30) Foreign Application Priority Data
Nov. 29, 2021 (JP) 2021-193565

(51) Int. Cl. H02K 3/52; H02K 1/14; H02K 3/28

(52) U.S. Cl. CPC H02K 3/522; H02K 1/146; H02K 3/28; H02K 2203/09; H02K 2203/12

(57) ABSTRACT

A stator includes a stator core, a plurality of windings and a plurality of insulators. The stator core is constituted of a plurality of core constituent parts each of which includes a yoke constituent part and a tooth protruding from the yoke constituent part. Each of the windings has a plurality of winding sections each of which is wound around a corresponding one of the teeth of the stator core. Each of the insulators has a plurality of insulating parts, each of which is mounted to a corresponding one of the core constituent parts to insulate the tooth included in the corresponding core constituent part and the winding section wound around the tooth from each other, and a connecting ring that connects the insulating parts. Each of the connecting rings of the insulators has an inner diameter set to be greater than an outer diameter of a rotor.

### CROSS-REFERENCE TO RELATED APPLICATIONS

The present application is a continuation application of International Application No. PCT/JP2022/038482 filed on Oct. 14, 2022, which is based on and claims priority from Japanese Patent Application No. 2021-193565 filed on Nov. 29, 2021. The entire contents of these applications are incorporated by reference into the present application.

### BACKGROUND

### 1 Technical Field

The present disclosure relates to brushless motors.

### 2 Description of Related Art

There is known a brushless motor as disclosed in, for example, Japanese Patent No. JP 5502115 B2. The brushless motor includes a stator and a rotor that is arranged inside the stator. The stator includes a stator core, a plurality of windings and a plurality of insulators. The stator core is constituted of a plurality of core constituent parts. Each of the core constituent parts includes a corresponding one of a plurality of yoke constituent parts, which together constitute an annular yoke that is segmented in a circumferential direction thereof, and a corresponding one of a plurality of teeth that radially protrude respectively from the yoke constituent parts.

Each of the windings has a plurality of winding sections each of which is wound around a corresponding one of the teeth. Each of the insulators has a plurality of insulating parts, each of which is mounted to a corresponding one of the core constituent parts to insulate the corresponding tooth included in the corresponding core constituent part and the corresponding winding section wound around the corresponding tooth from each other, and a connecting ring that connects the insulating parts. Moreover, all the connecting rings of the insulators are arranged at an end of the stator on one axial side thereof. Furthermore, each of the connecting rings of the insulators has an inner diameter set to be less than an outer diameter of the rotor that is arranged inside the stator.

### SUMMARY

However, in the case where all the connecting rings are arranged at the end of the stator on one axial side thereof and each of the connecting rings has an inner diameter set to be less than the outer diameter of the rotor as in the brushless motor disclosed in the aforementioned patent document, the rotor cannot be inserted inside the stator from the previously-mentioned axial side of the stator. Therefore, there is a constraint that the rotor must be inserted inside the stator from the other axial side of the stator.

The present disclosure has been accomplished in view of the above problem. According to a first aspect of the present disclosure, there is provided a brushless motor. The brushless motor includes a stator and a rotor that is arranged inside the stator. The stator includes a stator core, a plurality of windings and a plurality of insulators. The stator core is constituted of a plurality of core constituent parts. Each of the core constituent parts includes a corresponding one of a plurality of yoke constituent parts, which together constitute an annular yoke that is segmented in a circumferential direction thereof, and a corresponding one of a plurality of teeth that radially protrude respectively from the yoke constituent parts. Each of the windings has a plurality of winding sections each of which is wound around a corresponding one of the teeth. Each of the insulators has a plurality of insulating parts, each of which is mounted to a corresponding one of the core constituent parts to insulate the corresponding tooth included in the corresponding core constituent part and the corresponding winding section wound around the corresponding tooth from each other, and a connecting ring that connects the insulating parts. Moreover, each of the connecting rings of the insulators has an inner diameter set to be greater than an outer diameter of the rotor.

In the above brushless motor, the inner diameter of each of the connecting rings of the insulators is set to be greater than the outer diameter of the rotor. Consequently, it becomes possible to insert the rotor inside the stator from a first axial side of the stator; it also becomes possible to insert the rotor inside the stator from a second axial side of the stator. That is, it becomes possible to insert the rotor inside the stator from both axial sides of the stator.

A brushless motor according to a second aspect of the present disclosure results from a further implementation of the brushless motor according to the first aspect of the present disclosure. In the brushless motor according to the second aspect of the present disclosure, each of the connecting rings of the insulators has an outer diameter set to be less than an inner diameter of the stator core.

In the above brushless motor, the outer diameter of each of the connecting rings of the insulators is set to be less than the inner diameter of the stator core. Consequently, it becomes possible to arrange the connecting rings of the insulators inside the stator core, thereby suppressing increase in the axial size of the stator.

A brushless motor according to a third aspect of the present disclosure results from a further implementation of the brushless motor according to the first or second aspect of the present disclosure. In the brushless motor according to the third aspect of the present disclosure, all the connecting rings of the insulators are arranged radially between the stator core and the rotor.

In the above brushless motor, all the connecting rings of the insulators are arranged radially between the stator core and the rotor. Consequently, it becomes possible to effectively utilize the radial space between the stator core and the rotor as an arrangement space of the connecting rings.

A brushless motor according to a fourth aspect of the present disclosure results from a further implementation of the brushless motor according to any one of the first to third aspects of the present disclosure. In the brushless motor according to the fourth aspect of the present disclosure, all the connecting rings of the insulators are arranged in alignment with each other in an axial direction of the stator.

In the above brushless motor, all the connecting rings of the insulators are arranged in alignment with each other in the axial direction of the stator. Consequently, it becomes possible to suppress radial protrusion of the connecting rings, thereby suppressing increase in the radial size of the stator.

A brushless motor according to a fifth aspect of the present disclosure results from a further implementation of the brushless motor according to any one of the first to fourth aspects of the present disclosure. In the brushless motor according to the fifth aspect of the present disclosure, a first connecting ring, which is located furthest toward the first axial side of the stator among all the connecting rings of the insulators, has a first-axial-side end thereof located further toward the second axial side of the stator than first-axial-side ends of the winding sections of the windings are.

In the above brushless motor, the first connecting ring, which is located furthest toward the first axial side of the stator among all the connecting rings of the insulators, has the first-axial-side end thereof located further toward the second axial side of the stator than the first-axial-side ends of the winding sections of the windings are. Consequently, it becomes possible to suppress protrusion of the first-axial-side end of the first connecting ring from the first-axial-side ends of the winding sections of the windings, thereby suppressing increase in the axial size of the stator.

A brushless motor according to a sixth aspect of the present disclosure results from a further implementation of the brushless motor according to the fifth aspect of the present disclosure. In the brushless motor according to the sixth aspect of the present disclosure, a second connecting ring, which is located furthest toward the second axial side of the stator among all the connecting rings of the insulators, has a second-axial-side end thereof located further toward the first axial side of the stator than second-axial-side ends of the winding sections of the windings are.

In the above brushless motor, the second connecting ring, which is located furthest toward the second axial side of the stator among all the connecting rings of the insulators, has the second-axial-side end thereof located further toward the first axial side of the stator than the second-axial-side ends of the winding sections of the windings are. Consequently, it becomes possible to suppress protrusion of the second-axial-side end of the second connecting ring from the second-axial-side ends of the winding sections of the windings, thereby suppressing increase in the axial size of the stator.

A brushless motor according to a seventh aspect of the present results from a further implementation of the brushless motor according to the fifth or sixth aspect of the present disclosure. In the brushless motor according to the seventh aspect of the present disclosure, all the connecting rings of the insulators are arranged at a first-axial-side end of the stator.

In the above brushless motor, all the connecting rings of the insulators are arranged at the first-axial-side end of the stator. Consequently, none of the connecting rings of the insulators are arranged at a second-axial-side end of the stator; thus, it becomes possible to simplify the configuration of the stator at the second-axial-side end thereof.

A brushless motor according to an eighth aspect of the present disclosure results from a further implementation of the brushless motor according to the sixth aspect of the present disclosure. In the brushless motor according to the eighth aspect of the present disclosure, the first connecting ring is arranged at the first-axial-side end of the stator; and the second connecting ring is arranged at the second-axial-side end of the stator.

In the above brushless motor, the first connecting ring is arranged at the first-axial-side end of the stator; and the second connecting ring is arranged at the second-axial-side end of the stator. That is, the first connecting ring and the second connecting ring are arranged respectively at the first-axial-side end and second-axial-side end of the stator. Consequently, it becomes possible to simplify, in a balanced manner, both the configuration of the stator at the first-axial-side end thereof and the configuration of the stator at the second-axial-side end thereof.

A brushless motor according to a ninth aspect of the present disclosure results from a further implementation of the brushless motor according to any one of the first to eighth aspects of the present disclosure. In the brushless motor according to the ninth aspect of the present disclosure, each of the windings includes a plurality of bridging wires that connect the winding sections of the winding with one another; and all the bridging wires of the windings are arranged radially outside the connecting rings of the insulators.

In the above brushless motor, each of the windings includes a plurality of bridging wires that connect the winding sections of the winding with one another; and all the bridging wires of the windings are arranged radially outside the connecting rings of the insulators. Consequently, it becomes possible to prevent the bridging wires of the windings from interfering with the connecting rings of the insulators when a plurality of stator constituent parts are assembled together to constitute the stator. As a result, it becomes possible to improve the work efficiency during the assembly of the stator constituent parts.

A brushless motor according to a tenth aspect of the present disclosure results from a further implementation of the brushless motor according to the ninth aspect of the present disclosure. In the brushless motor according to the tenth aspect of the present disclosure, the stator is constituted of a plurality of stator constituent parts each of which includes a predetermined number of the core constituent parts, one of the windings and one of the insulators. The stator constituent parts are assembled to one another in the axial direction of the stator. The bridging wires of the winding included in one of the stator constituent parts are arranged at positions where they do not interfere with the core constituent parts included in the remainder of the stator constituent parts during the assembly of the stator constituent parts to one another in the axial direction of the stator.

In the above brushless motor, the bridging wires of the winding included in one of the stator constituent parts are arranged at positions where they do not interfere with the core constituent parts included in the remainder of the stator constituent parts during the assembly of the stator constituent parts to one another in the axial direction of the stator. Consequently, it becomes possible to prevent the bridging wires from interfering with the core constituent parts during the assembly of the stator constituent parts. As a result, it becomes possible to improve the work efficiency during the assembly of the stator constituent parts.

A brushless motor according to an eleventh aspect of the present disclosure results from a further implementation of the brushless motor according to the tenth aspect of the present disclosure. In the brushless motor according to the eleventh aspect of the present disclosure, the bridging wires of the windings have been shaped, from a state of spreading toward a radially outer side of the stator constituent parts, toward a radially inner side of the stator constituent parts.

In the above brushless motor, the bridging wires of the windings have been shaped, from the state of spreading toward the radially outer side of the stator constituent parts, toward the radially inner side of the stator constituent parts. Consequently, it becomes possible to arrange all the bridging wires of the windings together in a radially inner region of the stator constituent parts.

### BRIEF DESCRIPTION OF THE DRAWINGS

FIG. 1 is a perspective view of a stator according to an embodiment of the present disclosure.

FIG. 2A is a perspective view of a U-phase stator constituent part.

FIG. 2B is a perspective view of a V-phase stator constituent part.

FIG. 2C is a perspective view of a W-phase stator constituent part.

FIG. 3 is a perspective view showing a winding section and a bridging wire both of which are formed by a winding in the U-phase stator constituent part.

FIG. 4A is a perspective view illustrating a process of assembling the stator constituent parts to one another.

FIG. 4B is a perspective view illustrating a state where the assembling process has progressed further than in FIG. 4A.

FIG. 4C is a perspective view illustrating a state where the stator constituent parts have been assembled together.

FIG. 5 is a longitudinal cross-sectional view showing the periphery of connecting rings.

FIG. 6 is a top view of the stator.

FIG. 7 is a side view of the stator.

FIG. 8 is a bottom view of the stator.

FIG. 9 is an enlarged view of a part A of FIG. 6.

FIG. 10 is an enlarged view of a part B of FIG. 8.

FIG. 11 is an explanatory diagram illustrating the shaping of U-phase bridging wires after the stator constituent parts are assembled together.

FIG. 12 is an explanatory diagram illustrating the shaping of V-phase bridging wires after the U-phase bridging wires are shaped.

FIG. 13 is an explanatory diagram illustrating the shaping of W-phase bridging wires after the V-phase bridging wires are shaped.

FIG. 14 is a perspective view illustrating the configuration of a brushless motor which includes the stator and a rotor.

FIG. 15 is a longitudinal cross-sectional view illustrating a first example of the cross-sectional structure of the brushless motor.

FIG. 16 is a longitudinal cross-sectional view illustrating a second example of the cross-sectional structure of the brushless motor.

FIG. 17 is a longitudinal cross-sectional view illustrating a third example of the cross-sectional structure of the brushless motor.

### DESCRIPTION OF EMBODIMENTS

Hereinafter, an embodiment of the present disclosure will be described with reference to the drawings.

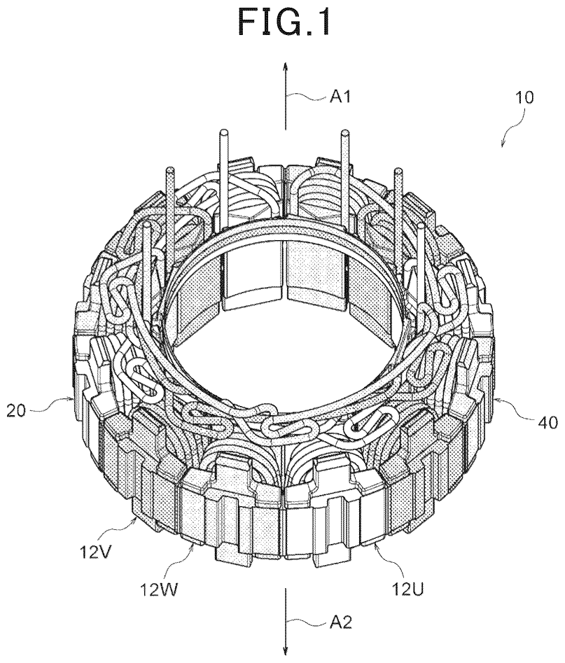

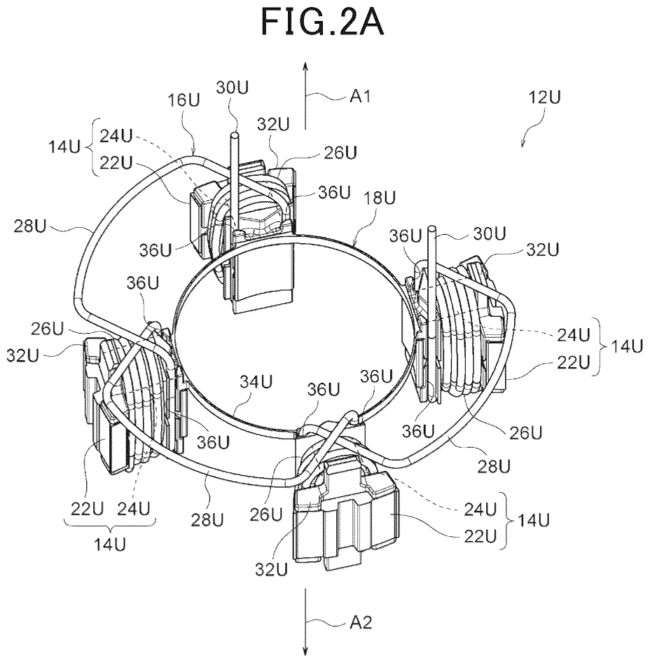

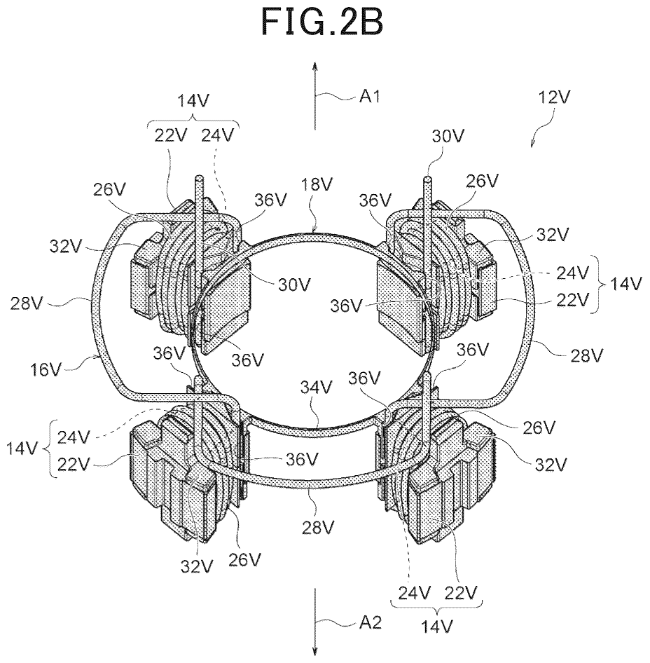

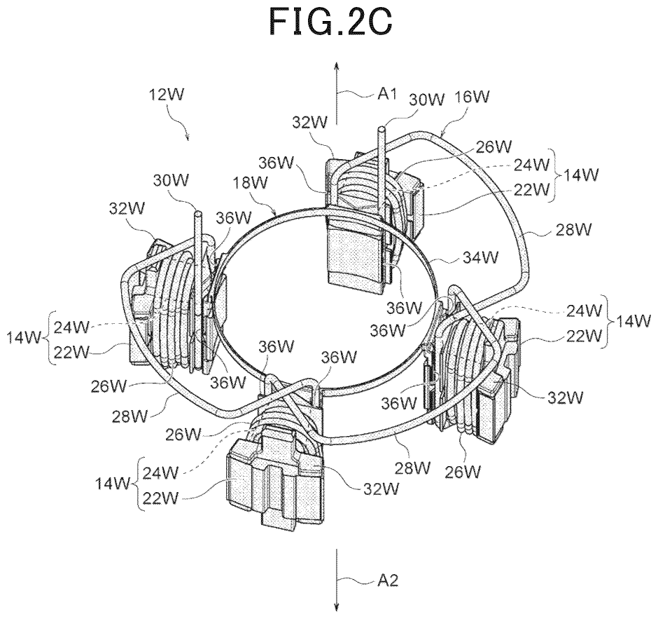

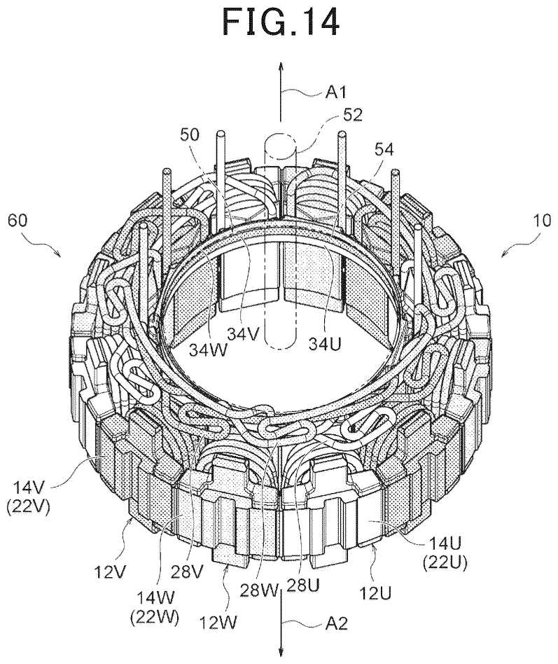

A stator 10 according to the embodiment of the present disclosure, which is shown in FIG. 1, is designed to be used in an inner rotor type brushless motor 60 (see FIG. 14) that will be described later. The brushless motor 60 may be, for example, an 8-pole, 12-slot brushless motor. It should be noted that: in the drawings, an arrow A1 indicates a first axial side of the stator 10; and an arrow A2 indicates a second axial side of the stator 10. The stator 10 is constituted of a U-phase stator constituent part 12U, a V-phase stator constituent part 12V and a W-phase stator constituent part 12W, which are respectively shown in FIGS. 2A to 2C.

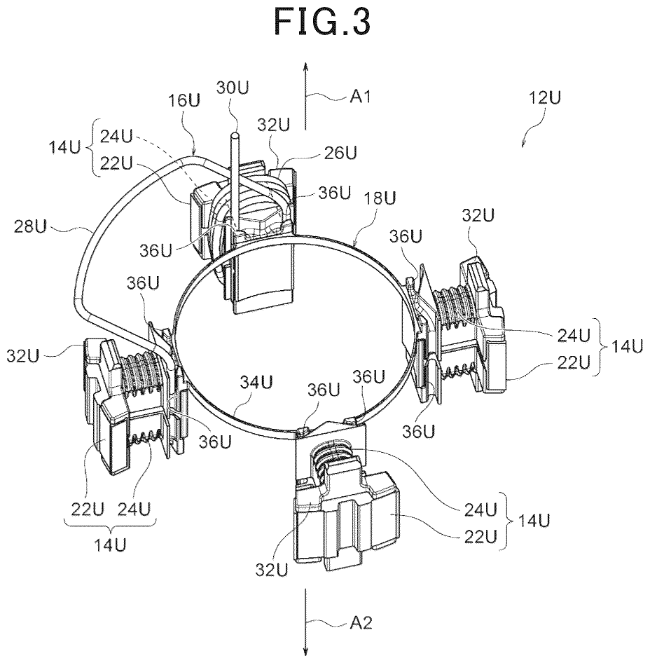

As shown in FIG. 2A (see also FIG. 3 as appropriate), the U-phase stator constituent part 12U includes a plurality of core constituent parts 14U, a winding 16U and an insulator 18U. The core constituent parts 14U, together with V-phase core constituent parts 14V and W-phase core constituent parts 14W which will be described later, constitute an annular stator core 20 (see FIG. 1). Each of the core constituent parts 14U includes a yoke constituent part 22U and a tooth 24U. In addition, the number of the core constituent parts 14U may be, for example, four.

The yoke constituent parts 22U, together with V-phase yoke constituent parts 22V and W-phase yoke constituent parts 22W which will be described later, constitute an annular yoke 40 (see FIG. 1). Each of the yoke constituent parts 22U is formed in an arc shape. Each of the teeth 24U is formed integrally with a corresponding one of the yoke constituent parts 22U into one piece, and protrudes radially inward from the corresponding yoke constituent part 22U (see FIG. 1).

The winding 16U, which constitutes a U-phase winding, includes a plurality of winding sections 26U and a plurality of bridging wires 28U. Each of the winding sections 26U is concentratedly wound around a corresponding one of the teeth 24U via a corresponding one of insulating parts 32U that will be described later. Moreover, the winding sections 26U are connected with one another via the bridging wires 28U. In addition, both terminal sections 30U of the winding 16U, which are provided respectively at opposite ends of the winding 16U, are led out from the corresponding teeth 24U to the first axial side of the stator constituent part 12U.

The insulator 18U is made of a resin, and has a plurality of insulating parts 32U and a connecting ring 34U formed integrally into one piece. The number of the insulating parts 32U is equal to the number of the core constituent parts 14U described above. Each of the insulating parts 32U is mounted to a corresponding one of the core constituent parts 14U, thereby being integrated with the corresponding core constituent part 14U into one piece. In addition, the insulating parts 32U may be arranged, for example, at equal intervals.

In each of the insulating parts 32U, there are formed a pair of guide grooves 36U. Specifically, in each of the insulating parts 32U, the pair of guide grooves 36U are formed respectively in a pair of side surfaces of the insulating part 32U. It should be noted that the side surfaces of the insulating parts 32U constitute side surfaces of V-shaped slots formed between adjacent teeth 24U. Each of the guide grooves 36U extends in an axial direction of the stator constituent part 12U. In addition, inner peripheral portions of the insulating parts 32U are portions that form an inner circumferential surface of the stator 10; in each of the insulating parts 32U, the pair of guide grooves 36U are formed in the inner peripheral portion of the insulating part 32U.

In the pair of guide grooves 36U of each of the insulating parts 32U, there are respectively inserted a winding start portion and a winding finish portion of the corresponding winding section 26U. Each of the bridging wires 28U connects a corresponding pair of the winding start and winding finish portions of the adjacent winding sections 26U of the winding 16U. Moreover, each of the bridging wires 28U is arranged on the first axial side of the stator constituent part 12U. Furthermore, each of the bridging wires 28U has slack and spreads toward the radially outer side of the stator constituent part 12U. For each of the bridging wires 28U, a central part (i.e., a part extending between an adjacent pair of the core constituent parts 14U) of the bridging wire 28U is arranged at a position on the radially outer side of the stator core 20. Further, as will be described later, the bridging wires 28U, which are in the state of spreading toward the radially outer side of the stator constituent part 12U, are shaped toward the radially inner side of the stator constituent part 12U (see FIG. 1).

The connecting ring 34U is formed integrally with the inner peripheral portions of the insulating parts 32U into one piece. The connecting ring 34U is provided at the first-axial-side end of the stator constituent part 12U. The connecting ring 34U is formed in a ring shape along the circumferential direction of the stator constituent part 12U, and connects all the insulating parts 32U together.

The V-phase stator constituent part 12V, which is shown in FIG. 2B, has the same basic configuration as the U-phase stator constituent part 12U described above. Specifically, the V-phase stator constituent part 12V includes a plurality of core constituent parts 14V, a winding 16V and an insulator 18V. The core constituent parts 14V, the winding 16V and the insulator 18V respectively have the same configurations as the core constituent parts 14U, the winding 16U and the insulator 18U (see FIG. 2A).

The configuration of the V-phase stator constituent part 12V shown in FIG. 2B will be briefly explained below with reference to the explanation of the U-phase stator constituent part 12U given above. Each of the core constituent parts 14V includes a yoke constituent part 22V and a tooth 24V. The winding 16V, which constitutes a V-phase winding, includes a plurality of winding sections 26V and a plurality of bridging wires 28V. Both terminal sections 30V of the winding 16V, which are provided respectively at opposite ends of the winding 16V, are led out from the corresponding teeth 24V to the first axial side of the stator constituent part 12V. The insulator 18V has a plurality of insulating parts 32V and a connecting ring 34V formed integrally into one piece. In each of the insulating parts 32V, there are formed a pair of guide grooves 36V.

Each of the bridging wires 28V connects a corresponding pair of the winding start and winding finish portions of the adjacent winding sections 26V of the winding 16V. Moreover, each of the bridging wires 28V is arranged on the first axial side of the stator constituent part 12V. Furthermore, each of the bridging wires 28V has slack and spreads toward the radially outer side of the stator constituent part 12V. As will be described later, the bridging wires 28V, which are in the state of spreading toward the radially outer side of the stator constituent part 12V, are shaped toward the radially inner side of the stator constituent part 12V (see FIG. 1). The connecting ring 34V is formed integrally with inner peripheral portions of the insulating parts 32V into one piece, thereby connecting all the insulating parts 32V together.

The W-phase stator constituent part 12W, which is shown in FIG. 2C, has the same basic configuration as the U-phase stator constituent part 12U described above. Specifically, the W-phase stator constituent part 12W includes a plurality of core constituent parts 14W, a winding 16W and an insulator 18W. The core constituent parts 14W, the winding 16W and the insulator 18W respectively have the same configurations as the core constituent parts 14U, the winding 16U and the insulator 18U (see FIG. 2A).

The configuration of the W-phase stator constituent part 12W shown in FIG. 2C will be briefly explained below with reference to the explanation of the U-phase stator constituent part 12U given above. Each of the core constituent parts 14W includes a yoke constituent part 22W and a tooth 24W. The winding 16W, which constitutes a W-phase winding, includes a plurality of winding sections 26W and a plurality of bridging wires 28W. Both terminal sections 30W of the winding 16W, which are provided respectively at opposite ends of the winding 16W, are led out from the corresponding teeth 24W to the first axial side of the stator constituent part 12W. The insulator 18W has a plurality of insulating parts 32W and a connecting ring 34W formed integrally into one piece. In each of the insulating parts 32W, there are formed a pair of guide grooves 36W.

Each of the bridging wires 28W connects a corresponding pair of the winding start and winding finish portions of the adjacent winding sections 26W of the winding 16W. Moreover, each of the bridging wires 28W is arranged on the first axial side of the stator constituent part 12W. Furthermore, each of the bridging wires 28W has slack and spreads toward the radially outer side of the stator constituent part 12W. As will be described later, the bridging wires 28W, which are in the state of spreading toward the radially outer side of the stator constituent part 12W, are shaped toward the radially inner side of the stator constituent part 12W (see FIG. 1). The connecting ring 34W is formed integrally with inner peripheral portions of the insulating parts 32W into one piece, thereby connecting all the insulating parts 32W together.

It should be noted that in the following explanation, for the sake of convenience, the letters U, V and W will be omitted from the ends of the reference numerals when there is no distinction between the U, V and W phases with respect to the members and parts.

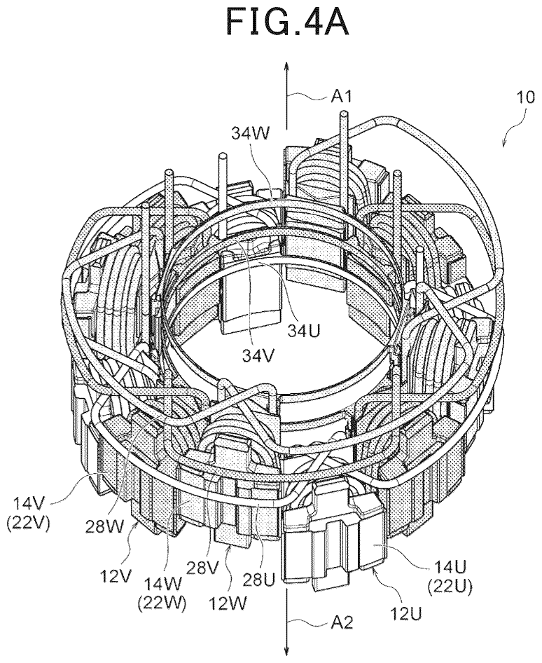

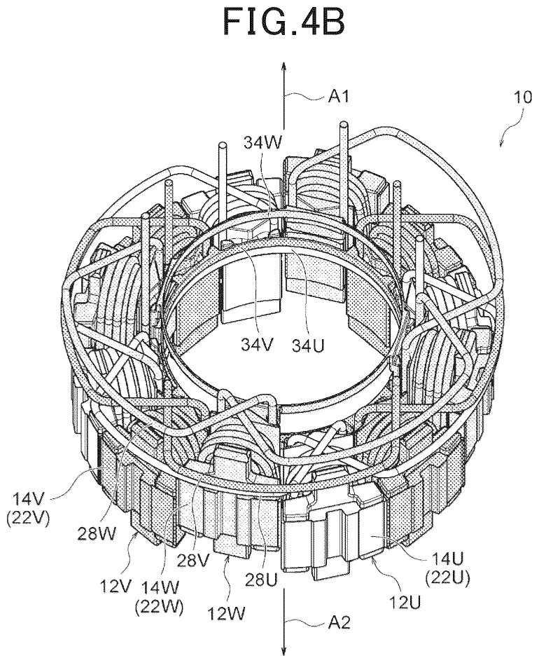

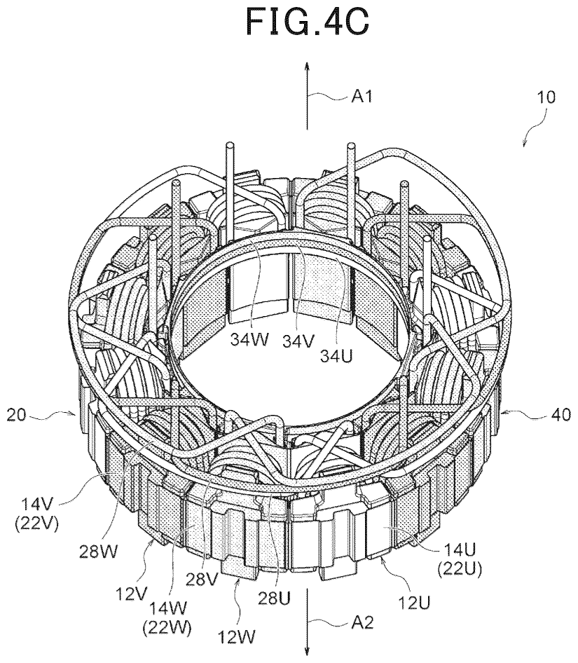

As shown in FIGS. 4A to 4C, the stator constituent parts 12U, 12V and 12W are assembled together to form the stator 10. For example, the stator constituent part 12V may be assembled to the stator constituent part 12U from the first axial side of the stator constituent part 12U; then, the stator constituent part 12W may be assembled to the stator constituent parts 12U and 12V from the first axial side of the stator constituent parts 12U and 12V.

In the stator 10 formed by assembling the stator constituent parts 12U, 12V and 12W together, the annular yoke 40 is constituted of the yoke constituent parts 22U, 22V and 22W. In other words, the yoke 40 is segmented in the circumferential direction thereof into the yoke constituent parts 22U, 22V and 22W. Each of the yoke constituent parts 22U, 22V and 22W is fitted between a pair of the yoke constituent parts 22 which are located adjacent to and respectively on opposite sides of the yoke constituent part in the circumferential direction.

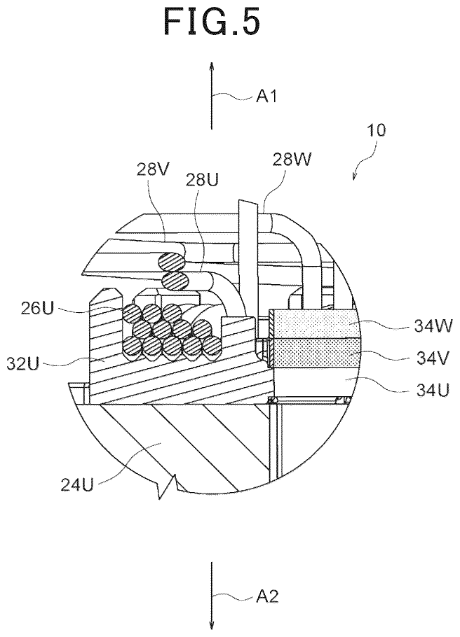

Moreover, in the stator 10, all the connecting rings 34U, 34V and 34W are arranged radially inside the yoke 40. For example, the connecting rings 34U, 34V and 34W may be arranged in alignment with each other in the axial direction of the stator 10. In other words, the connecting rings 34U, 34V and 34W may be arranged so that they overlap each other when viewed in the axial direction of the stator 10 (see also FIG. 5). In addition, the connecting rings 34U, 34V and 34W may be configured to have, for example, the same inner diameter and the same outer diameter.

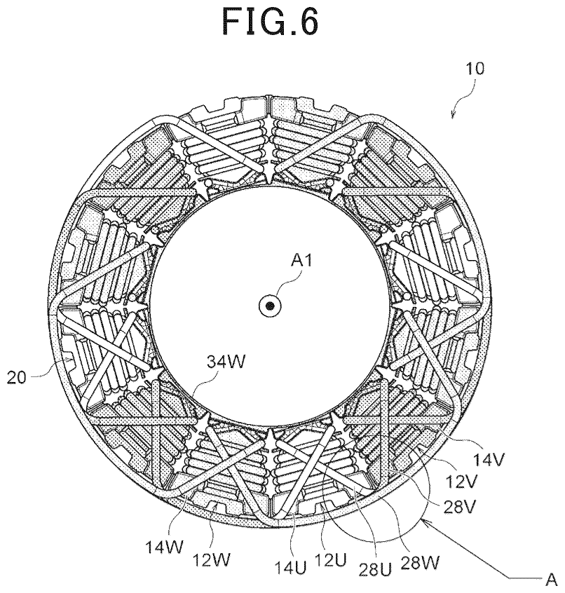

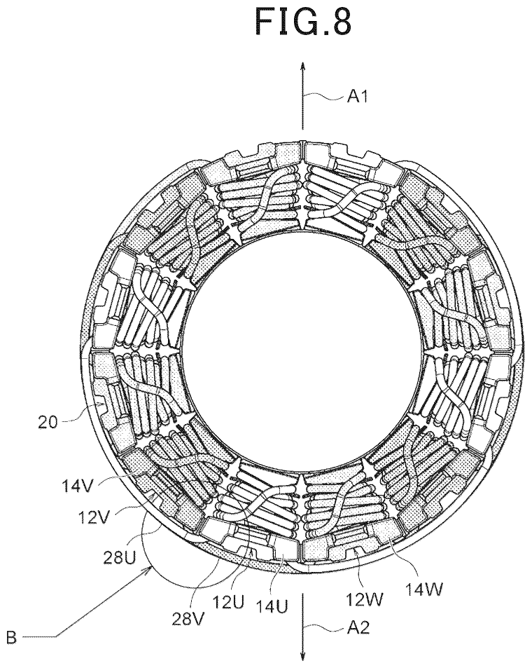

All the bridging wires 28U, 28V and 28W are arranged radially outside the connecting rings 34U, 34V and 34W. Moreover, all the bridging wires 28U, 28V and 28W are arranged on the first axial side of the stator constituent parts 12U, 12V and 12W, and have slack. As described above, the central parts (i.e., the parts extending between the adjacent core constituent parts 14U) of the bridging wires 28U are arranged at positions on the radially outer side of the stator core 20 (see also FIGS. 6 and 8). Similarly, the central parts (i.e., the parts extending between the adjacent core constituent parts 14V) of the bridging wires 28V are arranged at positions on the radially outer side of the stator core 20. Moreover, the central parts (i.e., the parts extending between the adjacent core constituent parts 14W) of the bridging wires 28W are arranged at positions on the radially outer side of the stator core 20.

The bridging wires 28U included in the U-phase stator constituent part 12U have slack such that when the stator constituent parts 12V and 12W are assembled to the stator constituent part 12U in the axial direction of the stator 10, the core constituent parts 14V and 14W can be inserted inside the bridging wires 28U that spread toward the radially outer side of the stator constituent part 12U. In other words, the bridging wires 28U included in the U-phase stator constituent part 12U are arranged at positions where they do not interfere with the core constituent parts 14V and 14W when the stator constituent parts 12V and 12W are assembled to the stator constituent part 12U in the axial direction of the stator 10.

Moreover, the bridging wires 28V included in the V-phase stator constituent part 12V have slack such that when the stator constituent part 12W is assembled to the stator constituent parts 12U and 12V in the axial direction of the stator 10, the core constituent parts 14W can be inserted inside the bridging wires 28V that spread toward the radially outer side of the stator constituent part 12V. In other words, the bridging wires 28V included in the V-phase stator constituent part 12V are arranged at positions where they do not interfere with the core constituent parts 14W when the stator constituent part 12W is assembled to the stator constituent parts 12U and 12V in the axial direction of the stator 10.

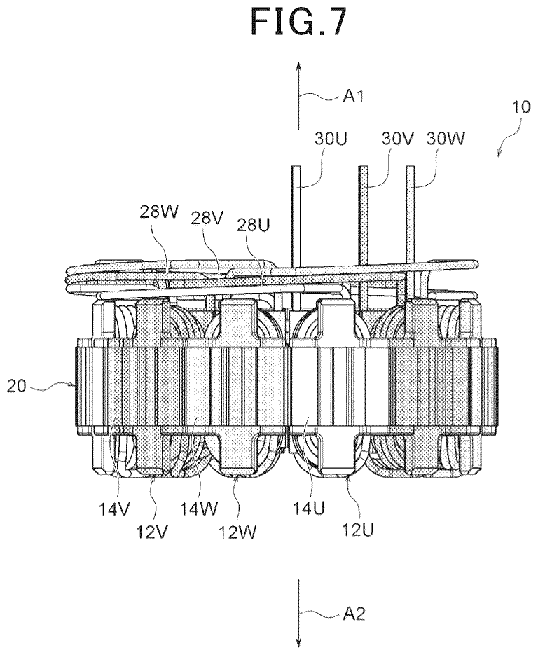

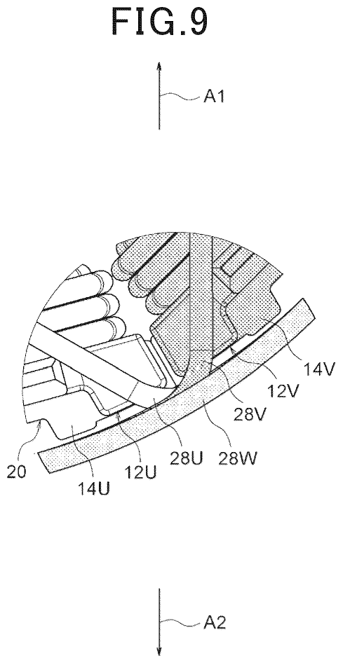

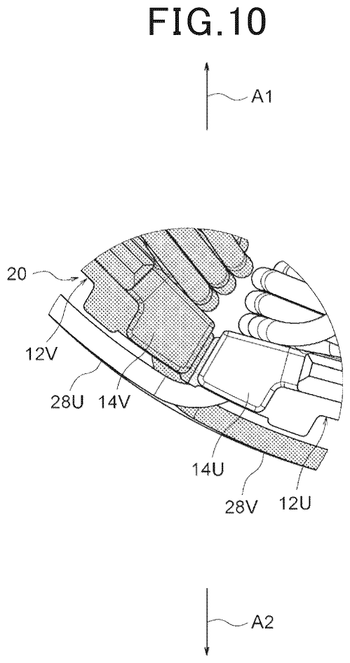

As shown in FIGS. 6 to 10, after the stator 10 is formed by assembling the stator constituent parts 12U, 12V and 12W together, the bridging wires 28U, 28V and 28W are located on the first axial side of the stator 10 and overlap each other in the axial direction of the stator 10.

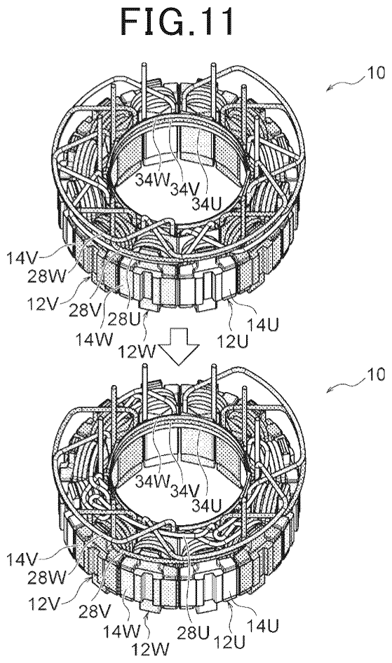

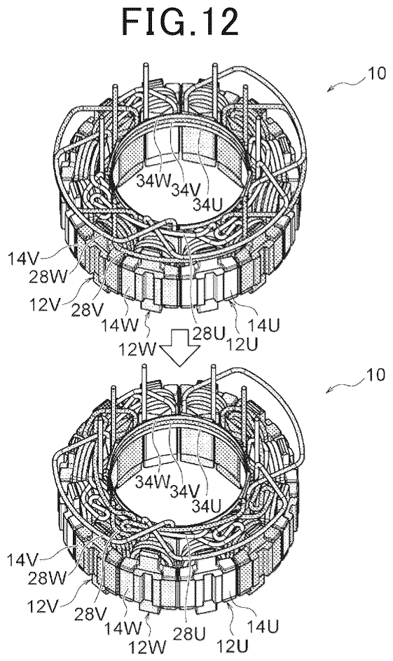

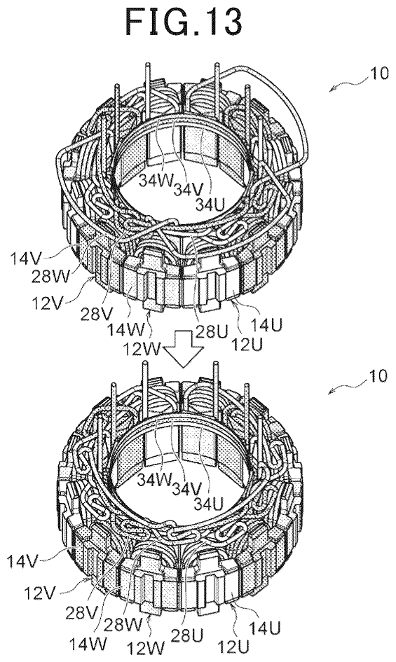

As shown in FIG. 11, after the stator constituent parts 12U, 12V and 12W are assembled together, the bridging wires 28U, which are in the state of spreading toward the radially outer side of the stator constituent part 12U, are shaped toward the radially inner side of the stator constituent part 12U. Similarly, as shown in FIG. 12, the bridging wires 28V, which are in the state of spreading toward the radially outer side of the stator constituent part 12V, are shaped toward the radially inner side of the stator constituent part 12V. Moreover, as shown in FIG. 13, the bridging wires 28W, which are in the state of spreading toward the radially outer side of the stator constituent part 12W, are shaped toward the radially inner side of the stator constituent part 12W. After being shaped as above, all the bridging wires 28U, 28V and 28W are still maintained in the state of being arranged radially outside the connecting rings 34U, 34V and 34W.

As shown in FIG. 14, a rotor 50 is inserted radially inside the stator 10. The rotor 50 has a rotor shaft 52 and a rotor main body 54. The stator 10 and the rotor 50 together constitute the brushless motor 60.

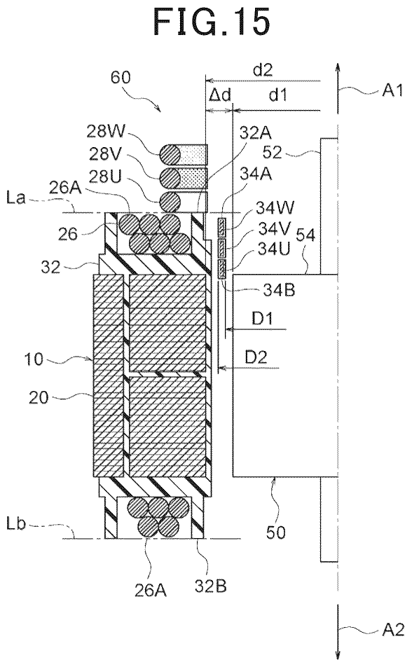

As shown in FIG. 15, all the connecting rings 34U, 34V and 34W are arranged at the first-axial-side end of the stator 10. The connecting rings 34U, 34V and 34W, which are arranged in alignment with each other in the axial direction of the stator 10, have the same inner diameter D1. Moreover, the inner diameter D1 of the connecting rings 34U, 34V and 34W is set to be greater than an outer diameter d1 of the rotor 50. The outer diameter d1 of the rotor 50 is represented by the diameter of an outer circumferential surface of the rotor 50.

Furthermore, the connecting rings 34U, 34V and 34W have an outer diameter D2 set to be less than an inner diameter d2 of the stator core 20. The inner diameter d2 of the stator core 20 is represented by the diameter of an inner circumferential surface of the stator core 20. The connecting rings 34U, 34V and 34W are arranged radially between the stator core 20 and the rotor 50 (i.e., within the dimensional difference Δd between the outer diameter d1 of the rotor 50 and the inner diameter d2 of the stator core 20).

Among the connecting rings 34U, 34V and 34W, the connecting ring 34W is located furthest toward the first axial side of the stator 10. Moreover, the first-axial-side end 34A of the connecting ring 34W is located further toward the second axial side of the stator 10 than the first-axial-side ends 26A of the winding sections 26 are (i.e., than a line La extending in a radial direction of the stator 10 through the ends 26A is). Furthermore, the first-axial-side end 34A of the connecting ring 34W is located further toward the second axial side of the stator 10 than the first-axial-side ends 32A of inner peripheral walls of the insulating parts 32 are. In addition, the connecting ring 34W is an example of a “first connecting ring”.

On the other hand, among the connecting rings 34U, 34V and 34W, the connecting ring 34U is located furthest toward the second axial side of the stator 10. Moreover, the second-axial-side end 34B of the connecting ring 34U is located further toward the first axial side of the stator 10 than the second-axial-side ends 26B of the winding sections 26 are (i.e., than a line Lb extending in the radial direction of the stator 10 through the ends 26B is). Furthermore, the second-axial-side end 34B of the connecting ring 34U is located further toward the first axial side of the stator 10 than the second-axial-side ends 32B of the inner peripheral walls of the insulating parts 32 are. In addition, the connecting ring 34U is an example of a “second connecting ring”.

Next, operation and effects of the brushless motor 60 according to the present embodiment will be described.

As described above, in the brushless motor 60 according to the present embodiment, each of the connecting rings 34U, 34V and 34W has the inner diameter D1 set to be greater than the outer diameter d1 of the rotor 50 that is arranged inside the stator 10. Consequently, it becomes possible to insert the rotor 50 inside the stator 10 from the first axial side of the stator 10; it also becomes possible to insert the rotor 50 inside the stator 10 from the second axial side of the stator 10. That is, it becomes possible to insert the rotor 50 inside the stator 10 from both axial sides of the stator 10.

Moreover, each of the connecting rings 34U, 34V and 34W has the outer diameter D2 set to be less than the inner diameter d2 of the stator core 20. Consequently, it becomes possible to arrange the connecting rings 34U, 34V and 34W inside the stator core 20, thereby suppressing increase in the axial size of the stator 10.

Furthermore, all the connecting rings 34U, 34V and 34W are arranged radially between the stator core 20 and the rotor 50 (i.e., within the dimensional difference Δd). Consequently, it becomes possible to effectively utilize the radial space between the stator core 20 and the rotor 50 as an arrangement space of the connecting rings 34U, 34V and 34W.

Furthermore, all the connecting rings 34U, 34V and 34W are arranged in alignment with each other in the axial direction of the stator 10. Consequently, it becomes possible to suppress radial protrusion of the connecting rings 34U, 34V and 34W, thereby suppressing increase in the radial size of the stator 10.

Furthermore, the connecting ring 34W, which is located furthest toward the first axial side of the stator 10 among the connecting rings 34U, 34V and 34W, has the first-axial-side end 34A thereof located further toward the second axial side of the stator 10 than the first-axial-side ends 26A of the winding sections 26 are. Consequently, it becomes possible to suppress protrusion of the first-axial-side end 34A of the connecting ring 34W from the first-axial-side ends 26A of the winding sections 26, thereby suppressing increase in the axial size of the stator 10.

Furthermore, the connecting ring 34U, which is located furthest toward the second axial side of the stator 10 among the connecting rings 34U, 34V and 34W, has the second-axial-side end 34B thereof located further toward the first axial side of the stator 10 than the second-axial-side ends 26B of the winding sections 26 are. Consequently, it becomes possible to suppress protrusion of the second-axial-side end 34B of the connecting ring 34U from the second-axial-side ends 26B of the winding sections 26, thereby suppressing increase in the axial size of the stator 10.

Furthermore, all the connecting rings 34U, 34V and 34W are arranged at the first-axial-side end of the stator 10. Consequently, none of the connecting rings 34U, 34V and 34W are arranged at the second-axial-side end of the stator 10; thus, it becomes possible to simplify the configuration of the stator 10 at the second-axial-side end thereof.

Furthermore, the windings 16U, 16V and 16W include the bridging wires 28U, 28V and 28W that connect the winding sections 26U, 26V and 26W; and all the bridging wires 28U, 28V and 28W are arranged radially outside the connecting rings 34U, 34V and 34W. Consequently, it becomes possible to prevent the bridging wires 28U, 28V and 28W from interfering with the connecting rings 34U, 34V and 34W during the assembly of the stator constituent parts 12U, 12V and 12W to one another. As a result, it becomes possible to improve the work efficiency during the assembly of the stator constituent parts 12U, 12V and 12W.

Furthermore, the bridging wires 28U included in the U-phase stator constituent part 12U are arranged at positions where they do not interfere with the core constituent parts 14V and 14W when the stator constituent parts 12V and 12W are assembled to the stator constituent part 12U in the axial direction of the stator 10. Consequently, it becomes possible to prevent the bridging wires 28U from interfering with the core constituent parts 14V and 14W when the stator constituent parts 12V and 12W are assembled to the stator constituent part 12U in the axial direction of the stator 10. As a result, it becomes possible to improve the work efficiency during the assembly of the stator constituent parts 12U, 12V and 12W.

Furthermore, the bridging wires 28V included in the V-phase stator constituent part 12V are arranged at positions where they do not interfere with the core constituent parts 14W when the stator constituent part 12W is assembled to the stator constituent parts 12U and 12V in the axial direction of the stator 10. Consequently, it becomes possible to prevent the bridging wires 28V from interfering with the core constituent parts 14W when the stator constituent part 12W is assembled to the stator constituent parts 12U and 12V in the axial direction of the stator 10. As a result, it becomes possible to improve the work efficiency during the assembly of the stator constituent parts 12U, 12V and 12W.

Furthermore, each of the bridging wires 28 is shaped, from the state of spreading toward the radially outer side of the stator constituent parts 12, toward the radially inner side of the stator constituent parts 12. Consequently, it becomes possible to arrange all the bridging wires 28 together in a radially inner region of the stator constituent parts 12.

Next, modifications of the above-described embodiment of the present disclosure will be described.

In the above-described embodiment, all the connecting rings 34U, 34V and 34W are arranged at the first-axial-side end of the stator 10. Alternatively, the connecting rings 34U, 34V and 34W may be arranged as follows.

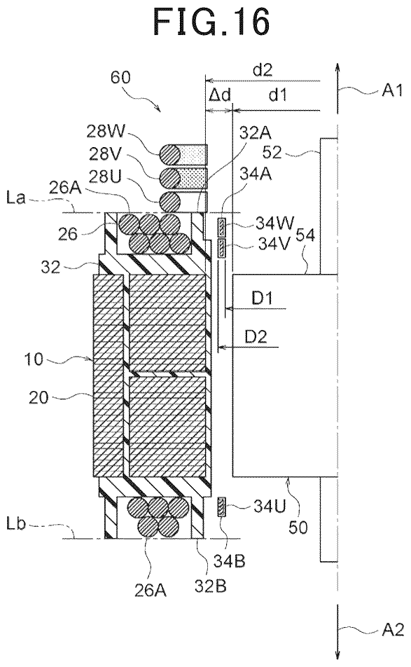

For example, in a modification shown in FIG. 16, the connecting rings 34V and 34W are arranged at the first-axial-side end of the stator 10, whereas the connecting ring 34U is arranged at the second-axial-side end of the stator 10. In this case, the connecting rings 34V and 34W are examples of “first connecting rings”; and the connecting ring 34U is an example of a “second connecting ring”. In the modification shown in FIG. 16, the connecting rings 34U, 34V and 34W are arranged in a distributed manner at the first-axial-side end and second-axial-side end of the stator 10; thus, it becomes possible to simplify, in a balanced manner, both the configuration of the stator 10 at the first-axial-side end thereof and the configuration of the stator 10 at the second-axial-side end thereof.

In addition, although not shown in the drawings, it is also possible to arrange only the connecting ring 34W at the first-axial-side end of the stator 10 while arranging both the connecting rings 34U and 34V at the second-axial-side end of the stator 10. In this case, the connecting ring 34W is an example of a “first connecting ring”; and the connecting rings 34U and 34V are examples of “second connecting rings”. In this case as well, the connecting rings 34U, 34V and 34W are arranged in a distributed manner at the first-axial-side end and second-axial-side end of the stator 10; thus, it becomes possible to simplify, in a balanced manner, both the configuration of the stator 10 at the first-axial-side end thereof and the configuration of the stator 10 at the second-axial-side end thereof.

Moreover, in the case of the connecting ring 34U being arranged at the second-axial-side end of the stator 10, the second-axial-side end 34B of the connecting ring 34U may be located further toward the first axial side of the stator 10 than the second-axial-side ends 26B of the winding sections 26 are. In this case as well, it is possible to suppress protrusion of the second-axial-side end 34B of the connecting ring 34U from the second-axial-side ends 26B of the winding sections 26, thereby suppressing increase in the axial size of the stator 10.

In the above-described embodiment, all the connecting rings 34U, 34V and 34W are arranged in alignment with each other in the axial direction of the stator 10. Alternatively, one of the connecting rings 34U, 34V and 34W may be radially offset with respect to the remainder of the connecting rings 34U, 34V and 34W. In other words, the inner and outer diameters of any of the connecting rings 34U, 34V and 34W may be set to be different from those of the remainder of the connecting rings 34U, 34V and 34W.

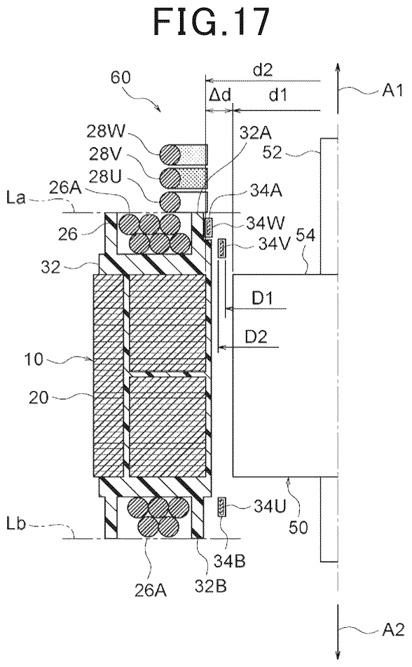

For example, in a modification shown in FIG. 17, the connecting ring 34W is arranged radially outside the connecting rings 34U and 34V.

Further, in the modifications shown in FIGS. 16 and 17, part of the connecting ring 34U in the axial direction may radially overlap part of the stator core 20 in the axial direction. In other words, part of the connecting ring 34U in the axial direction may be inserted into the radial gap between the stator core 20 and the rotor 50.

Similarly, in the modifications shown in FIGS. 16 and 17, part of the connecting ring 34V in the axial direction may radially overlap part of the stator core 20 in the axial direction. In other words, part of the connecting ring 34V in the axial direction may be inserted into the radial gap between the stator core 20 and the rotor 50.

In the above-described embodiment, the bridging wires 28U, 28V and 28W are shaped, from the state of spreading toward the radially outer side of the stator constituent parts 12U, 12V and 12W, toward the radially inner side of the stator constituent parts 12U, 12V and 12W. Alternatively, the bridging wires 28U, 28V and 28W may remain in the state of spreading toward the radially outer side of the stator constituent parts 12U, 12V and 12W, without being shaped from the state.

In the above-described embodiment, the stator 10 is configured so that the stator constituent parts 12U, 12V and 12W are assembled in this order. However, the assembly order of the stator constituent parts 12U, 12V and 12W is not limited to the above order. That is, in FIGS. 4A to 4C, the stator constituent part 12U may be replaced with the stator constituent part 12V or the stator constituent part 12W; the stator constituent part 12V may be replaced with the stator constituent part 12U or the stator constituent part 12W; and the stator constituent part 12W may be replaced with the stator constituent part 12U or the stator constituent part 12V.

In the above-described embodiment, the brushless motor 60 is configured as an 8-pole, 12-slot brushless motor. Alternatively, the brushless motor 60 may have a different combination of the number of magnetic poles and the number of slots.

While the above embodiment of the present disclosure has been described, it will be understood by those skilled in the art that the present disclosure is not limited to the above embodiment, but may be carried out through various modifications without departing from the spirit of the present disclosure.

All the document(s), patent application(s) and technical standard(s) mentioned in the present description are hereby incorporated by reference into the present description to the same extent as if each of the document(s), patent application(s) and technical standard(s) was specifically and individually indicated to be incorporated by reference into the present description.

What is claimed is:

1. A brushless motor comprising a stator and a rotor that is arranged inside the stator,
the stator comprising:
a stator core constituted of a plurality of core constituent parts, each of the core constituent parts including a corresponding one of a plurality of yoke constituent parts, which together constitute an annular yoke that is segmented in a circumferential direction thereof, and a corresponding one of a plurality of teeth that radially protrude respectively from the yoke constituent parts;
a plurality of windings each having a plurality of winding sections each of which is wound around a corresponding one of the teeth; and
a plurality of insulators each having a plurality of insulating parts, each of which is mounted to a corresponding one of the core constituent parts to insulate the corresponding tooth included in the corresponding core constituent part and the corresponding winding section wound around the corresponding tooth from each other, and a connecting ring that connects the insulating parts,
wherein:
each of the connecting rings of the insulators has an inner diameter set to be greater than an outer diameter of the rotor.

2. The brushless motor as set forth in claim 1, wherein:
each of the connecting rings of the insulators has an outer diameter set to be less than an inner diameter of the stator core.

3. The brushless motor as set forth in claim 1, wherein:
all the connecting rings of the insulators are arranged radially between the stator core and the rotor.

4. The brushless motor as set forth in claim 1, wherein:
all the connecting rings of the insulators are arranged in alignment with each other in an axial direction of the stator.

5. The brushless motor as set forth in claim 1, wherein:
a first connecting ring, which is located furthest toward a first axial side of the stator among all the connecting rings of the insulators, has a first-axial-side end thereof located further toward a second axial side of the stator than first-axial-side ends of the winding sections of the windings are.

6. The brushless motor as set forth claim 5, wherein:
a second connecting ring, which is located furthest toward the second axial side of the stator among all the connecting rings of the insulators, has a second-axial-side end thereof located further toward the first axial side of the stator than second-axial-side ends of the winding sections of the windings are.

7. The brushless motor as set forth claim 5, wherein:
all the connecting rings of the insulators are arranged at a first-axial-side end of the stator.

8. The brushless motor as set forth claim 6, wherein:
the first connecting ring is arranged at a first-axial-side end of the stator; and
the second connecting ring is arranged at a second-axial-side end of the stator.

9. The brushless motor as set forth in claim 1, wherein:
each of the windings includes a plurality of bridging wires that connect the winding sections of the winding with one another; and
all the bridging wires of the windings are arranged radially outside the connecting rings of the insulators.

10. The brushless motor as set forth in claim 9, wherein:
the stator is constituted of a plurality of stator constituent parts each of which includes a predetermined number of the core constituent parts, one of the windings and one of the insulators;
the stator constituent parts are assembled to one another in an axial direction of the stator; and
the bridging wires of the winding included in one of the stator constituent parts are arranged at positions where they do not interfere with the core constituent parts included in the remainder of the stator constituent parts during the assembly of the stator constituent parts to one another in the axial direction of the stator.

11. The brushless motor as set forth in claim 10, wherein:
the bridging wires of the windings have been shaped, from a state of spreading toward a radially outer side of the stator constituent parts, toward a radially inner side of the stator constituent parts.
